(19) United States
(12) Patent Application Publication
(10) Pub. No.: US 2019/0274293 A1
(43) Pub. Date: Sep. 12, 2019

(54) FISHING LURE DEVICE AND METHOD

(71) Applicant: Marcel Norman, Penn Hills, PA (US)

(72) Inventor: Marcel Norman, Penn Hills, PA (US)

(21) Appl. No.: 16/351,508

(22) Filed: Mar. 12, 2019

Related U.S. Application Data
(60) Provisional application No. 62/641,882, filed on Mar. 12, 2018.

(51) Int. Cl. A01K 85/01; A01K 83/06

(52) U.S. Cl. CPC A01K 85/01; A01K 83/06

(57) ABSTRACT

A fishing lure is disclosed herein. The fishing lure includes a fishing lure body, a tow eyelet, a support rod, a first hook eyelet, a first hook, a second eyelet and a second hook. The fishing lure allows a user to hook a fish without worrying about losing their bait.

### CROSS REFERENCE TO RELATED APPLICATION

The present application is related to and claims priority to U.S. Provisional Patent Application No. 62/641,882 filed Mar. 12, 2018, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of fishing and more specifically relates to fishing lure devices.

### 2. Description of Related Art

A fishing lure is a type of artificial fishing bait which is designed to attract a fish's attention. The lure uses movement, vibration, flash and color to bait fish. Many lures are equipped with one or more hooks that are used to ‘catch’ fish when they strike the lure. Some lures are placed to attract fish so a spear can be impaled into the fish or so the fish can be captured by hand. Most lures are attached to the end of a fishing line and have various styles of hooks attached to the body and are designed to elicit a strike resulting in a hook-set. Many lures are commercially made but some are hand-made such as fishing flies. Hand tying fly lures to match the hatch is considered a challenge by many amateur entomologists.

Anglers may use live bait and/or lures in order to attract fish. Live bait can be expensive, and often times, the bait is lost and cannot be reused once a fish is caught. Further, spending a day at a lake, river, pond, etc. and not catching numerous fish can leave anglers feeling disappointed. A suitable solution is desired.

U.S. Pat. No. 4,267,658 to Clarence C. Brown, et al. relates to a fishing lure simulating fish bait. The described fishing lure simulating fish bait includes a fishing lure designed to attract fish by means of having a smell and taste of natural baits, so that a fisherman may catch more fish; the invention of the present application presenting several different models thereof wherein a basic feature includes a hollow lure body containing a cut or ground up frozen bait of cotton saturated with a combination of liquid fish extracts for salt and fresh water fishing; the hollow body being perforated with openings so that the content can slowly ooze outwardly and into the water around the lure.

### BRIEF SUMMARY OF THE INVENTION

In view of the foregoing disadvantages inherent in the known fishing art, the present disclosure provides a novel fishing lure device and method. The general purpose of the present disclosure, which will be described subsequently in greater detail, is to provide an improved fishing lure device including a hollow interior that allows a user to hook a fish without worrying about losing their bait.

A fishing lure is disclosed herein. The fishing lure includes a fishing lure body may defined by a forward end, tail end, a right side, a left side, a top side, a bottom side, and a longitudinal axis extending between the forward end and the tail end. The fishing lure body may have a streamline shape in preferred embodiments along the longitudinal axis and may include a left lobe and a right lobe on each side of the longitudinal axis.

The fishing lure body may include an internal cavity, a bait portal, and a plurality of apertures through the fishing lure body to the internal cavity. The internal cavity may be sized and dimensioned to retain an item of bait. Further, the bait portal may be configured to receive the item of bait into the internal cavity and the plurality of apertures may be positioned on the top side of each of the left lobe and the right lobe.

A tow eyelet may be fixed to the fishing lure body, and configured to couple with a fishing line. A support rod may be fixed to the tow eyelet, extending toward the tail end of the fishing lure body, and at least partially embedded in the fishing lure body. In addition, a first hook eyelet partially imbedded in the fishing lure body, and fixed to the support rod; a first hook may be coupled to the first hook eyelet. Similarly, a second hook eyelet may be partially imbedded in the fishing lure body, and fixed to the support rod; and a second hook may be coupled to the second hook eyelet.

A method of using fishing lure is also disclosed herein. The method of using fishing lure may comprise the steps of: providing the fishing lure as above; and placing a live bait inside the internal cavity of the fishing lure body.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a fishing lure device and method, constructed and operative according to the teachings of the present disclosure.

FIG. 1 is a front perspective view of the fishing lure during an ‘in-use’ condition, according to an embodiment of the disclosure.

FIG. 2A is a top perspective view of the fishing lure of FIG. 1, according to an embodiment of the present disclosure.

FIG. 2B is a bottom perspective view of the fishing lure of FIG. 1, according to an embodiment of the present disclosure.

FIG. 3A is a bottom-side perspective view of the fishing lure of FIG. 1, according to an embodiment of the present disclosure.

FIG. 3B is a side-front perspective view of the fishing lure of FIG. 1, according to an embodiment of the present disclosure.

FIG. 4 is a side-front perspective view of the fishing lure of FIG. 1, according to an embodiment of the present disclosure.

FIG. 5 is a flow diagram illustrating a method of use for the fishing lure, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a fishing and more particularly to a fishing lure device and method as used to improve the ease and effectiveness of fishing.

Generally, disclosed is a device which is a uniquely-designed fishing lure designed to hook fish without worry of the user losing their bait. The device allows users to open the lure and place bait within a hollow interior, enabling anglers to attract fish without sacrificing live bait. The device may include a metal rod passing through the center of the bait, allowing for a set of hooks to be secured on the lure. As designed the device utilizes a set of open holes on the lure to allow bait scent to escape and attract fish. The device may offer a more effective lure for catching numerous fish while enjoying a day out on the water.

The device may include a rubber fishing lure capable of housing live bait. The lure may be comprised of a fish-like shape with an attachment link for securing the lure to a fishing line. The lure may feature the hollow interior and a slot-like portion on the top capable of receiving live bait. The exterior section of the lure may include a system of holes which allow live bait scent to escape from the lure. Live bait may be placed in the lure. The metal rod, passing through the lure, may secure a set of hooks on the lure used for catching fish. A live bait scent may escape through the holes while the lure is placed in water. The lure is intended to effectively attract fish, enabling anglers to catch more fish throughout the day. The device may be constructed using rubber and other suitable materials. The lure may be available in numerous sizes and colors, each suited to accommodate all user needs and preferences. Exact size, measurement, construction, and design specifications may vary upon manufacturing.

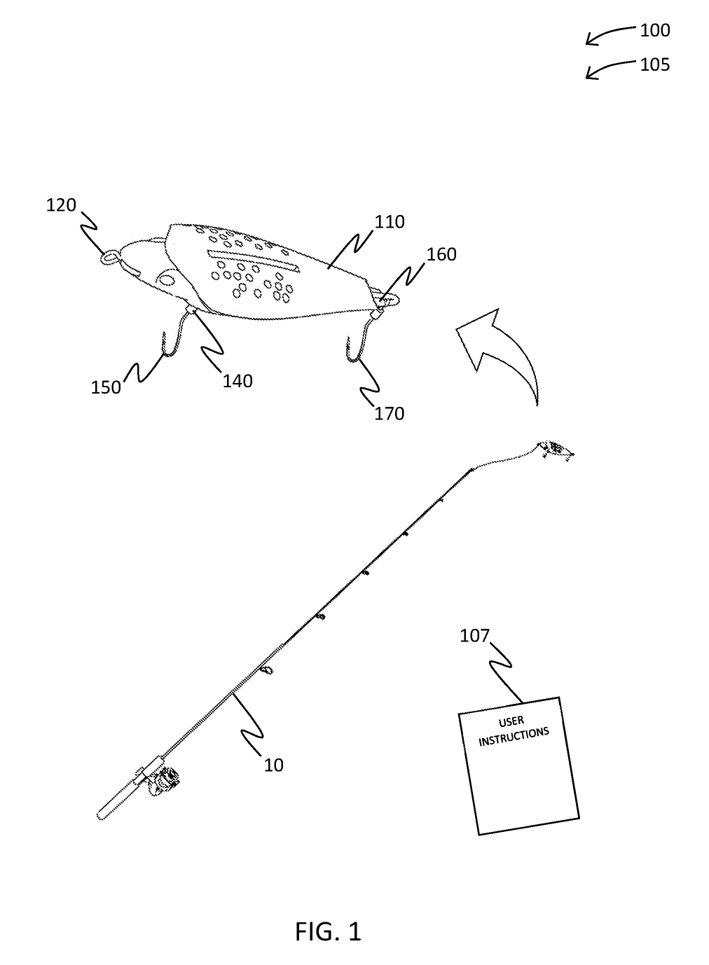

Referring now more specifically to the drawings by numerals of reference, there is shown in FIGS. 1-5, various views of a fishing lure 100.

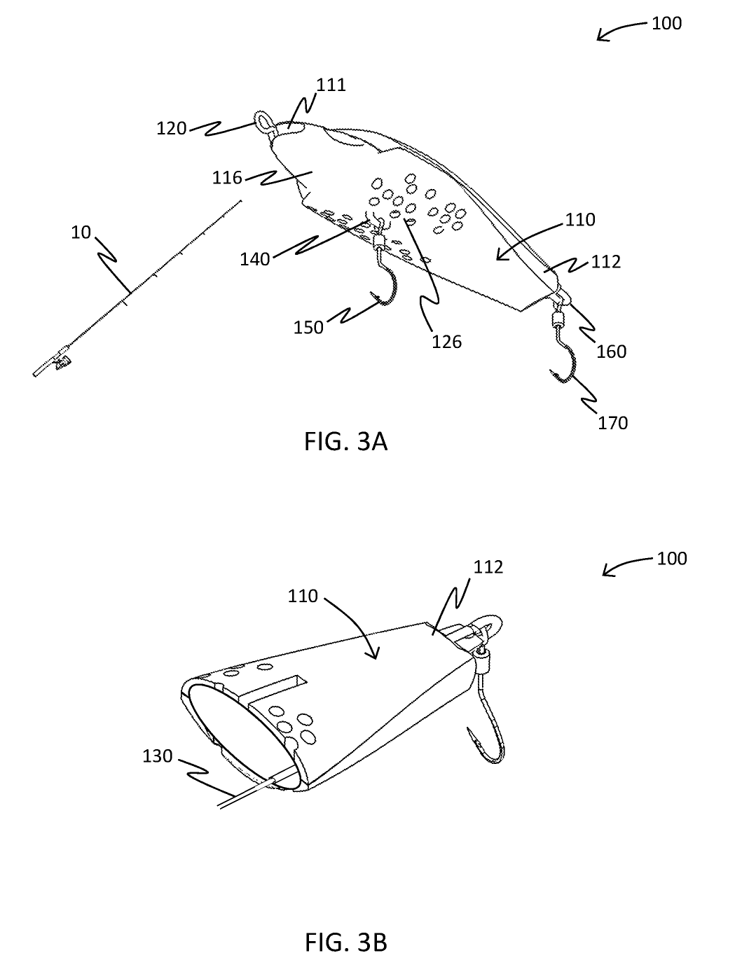

FIG. 1 shows a fishing lure 100 during an ‘in-use’ condition 150, according to an embodiment of the present disclosure. As Illustrated, the fishing lure 100 may include a fishing lure body 110, a tow eyelet 120, a support rod 130 (FIG. 3B), a first hook eyelet 140, a first hook 150, a second hook eyelet 160 and a second hook 170. The fishing lure body 110 may be configured to attach to a fishing line 10.

According to one embodiment, the fishing lure 100 may be arranged as a kit 105. The kit 105 may include a set of user instructions 107. The instructions 107 may detail functional relationships in relation to the structure of the fishing lure 100 (such that the fishing lure 100 can be used, maintained, or the like, in a preferred manner).

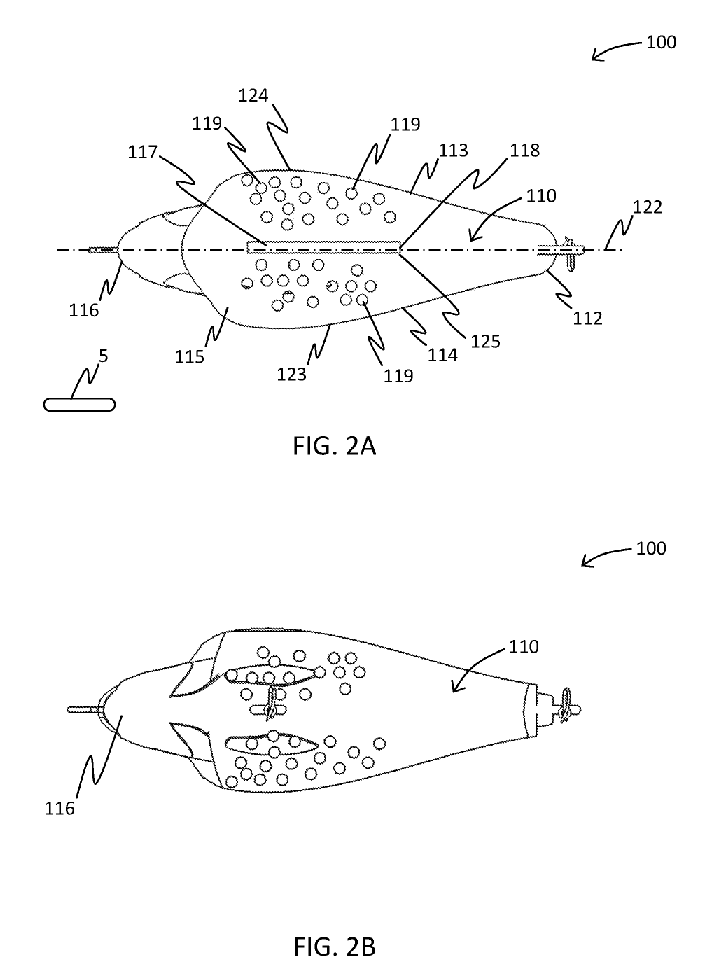

FIGS. 2A-2B show a top and bottom perspective view of the fishing lure 100 of FIG. 1, according to an embodiment of the present disclosure. The fishing lure body 110 may define a forward end 111, tail end 112, a right side 113, a left side 114, a top side 115, a bottom side 116, and a longitudinal axis 122 extending between the forward end 111 and the tail end 112. The fishing lure body 110 may have a streamline shape along the longitudinal axis 122 and may include a left lobe 123 and a right lobe 124 on each side of the longitudinal axis 122. In one embodiment, the fishing lure body 110 may be tapered proximate its forward end 111. In another embodiment, the fishing lure body 110 may be tapered proximate its tail end 112.

As shown, the fishing lure body 110 may include an internal cavity 117, a bait portal 118, and a plurality of apertures 119 through the fishing lure body 110 to the internal cavity 117. The internal cavity 117 may be sized and dimensioned to retain an item of bait 5. Further, the bait portal 118 may be configured to receive the item of bait 5 into the internal cavity 117 and the plurality of apertures 119 may be positioned on the top side 115 of each of the left lobe 123 and the right lobe 124. As shown, the plurality of apertures 119 may include at least two apertures 119 positioned on the left lobe 123. Similarly, the plurality of apertures 119 may include at least two apertures 119 positioned on the right lobe 124.

The bait portal 118 may be centered on the fishing lure body 110 between the forward end 111 and the tail end 112. Further, the bait portal 118 may be positioned between the left lobe 123 and the right lobe 124. As shown, the bait portal 118 may include an elongated aperture 125 through the fishing lure body 110 to the internal cavity 117 that is elongated respective to the longitudinal axis 122.

FIGS. 3A-3B show bottom-side and front-side perspective views of the fishing lure 100 of FIG. 1, according to an embodiment of the present disclosure. The tow eyelet 120 may be fixed to the fishing lure body 110, and configured to couple with a fishing line 10. As shown, the tow eyelet 120 may be fixed to the fishing lure body 110 proximate the forward end 111 of the fishing lure body 110. The support rod 130 may be fixed to the tow eyelet 120, extending toward the tail end 112 of the fishing lure body 110, and at least partially embedded in the fishing lure body 110.

In addition, a first hook eyelet 140 may be partially imbedded in the fishing lure body 110, and fixed to the support rod. As shown, the first hook eyelet 140 may be positioned proximate the bottom side 116 of the fishing lure body 110. Further, the first hook eyelet 140 may be positioned on the bottom side 116 of the fishing lure body 110 between its forward end 111 and its tail end 112. In another embodiment, the first hook eyelet 140 may be positioned in a center portion 126 of the bottom side 116 of the fishing lure body 110 between its forward end 111 and its tail end 112. A first hook 150 may be coupled to the first hook eyelet 140.

Similarly, a second hook eyelet 160 may be partially imbedded in the fishing lure body 110, and fixed to the support rod. The second hook 170 eyelet 160 may be positioned proximate the tail end 112 of the fishing lure body 110. A second hook 170 may be coupled to the second hook eyelet 160.

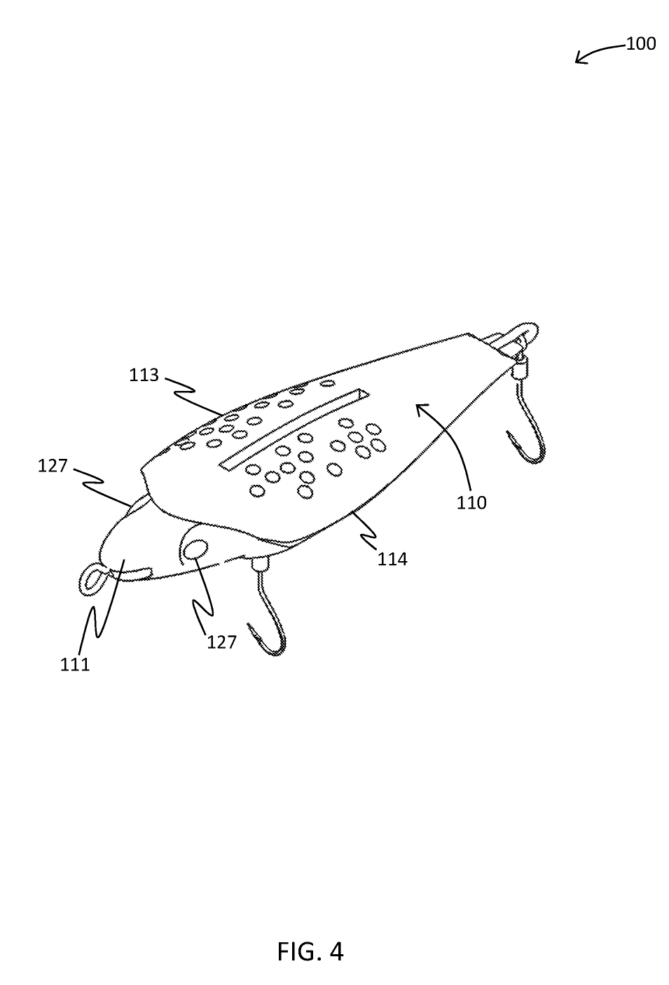

FIG. 4 shows a front-side perspective view of the fishing lure 100 of FIG. 1, according to an embodiment of the present disclosure. As shown, the fishing lure may further include a pair of imitation eyes 127 fixed to the fishing lure body 110. One of the pair of imitation eyes 127 may be positioned on the left side 114 of the fishing lure body 110, and the other of the pair of imitation eyes 127 may be positioned on the right side 113 of the fishing lure body 110. Further, the pair of imitation eyes 127 are further positioned proximate the forward end 111 of the fishing lure body 110.

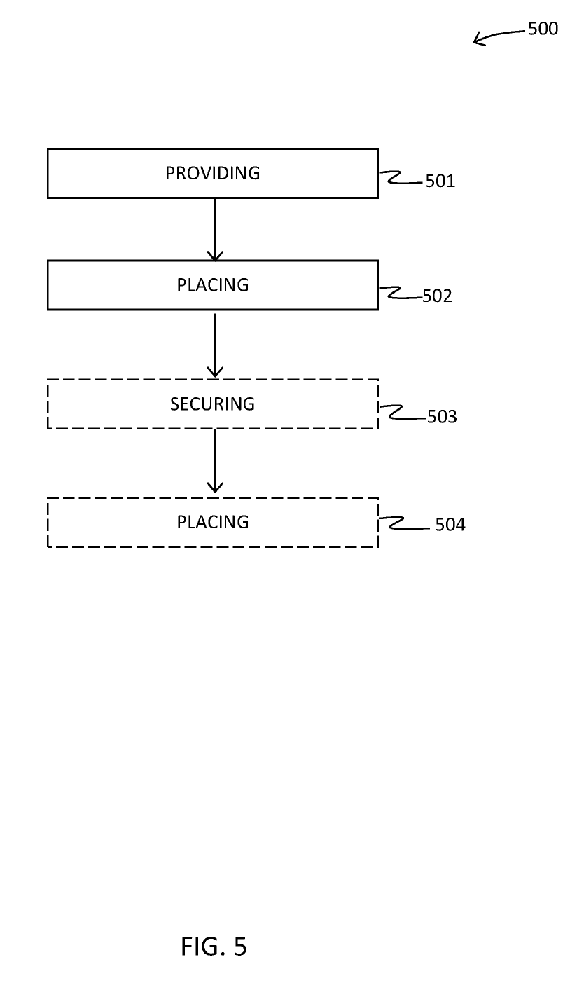

FIG. 5 is a flow diagram illustrating a method of using a fishing lure 500, according to an embodiment of the present disclosure. As illustrated, the method of using a fishing lure 500 may include the steps of: providing 501 the fishing lure as above; and placing 502 a live bait inside the internal cavity of the fishing lure body. Further steps may include: securing 503 a fishing line to the tow eyelet; and placing 504 the fishing lure into a body of water.

It should be noted that steps 503 and 504 are optional steps and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for fishing lure 100 (e.g., different step orders within above-mentioned list, elimination or addition of certain steps, including or excluding certain maintenance steps, etc.), are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A fishing lure comprising:
a fishing lure body defining a forward end, tail end, a right side, a left side, a top side, a bottom side, and a longitudinal axis extending between the forward end and the tail end, the fishing lure body having a streamline shape along the longitudinal axis and including a left lobe and a right lobe on each side of the longitudinal axis, the fishing lure body including an internal cavity, a bait portal, and a plurality of apertures through the fishing lure body to the internal cavity, said internal cavity sized and dimensioned to retain an item of bait, said bait portal configured to receive the item of bait into the internal cavity, said plurality of apertures positioned on the top side of each of the left lobe and the right lobe;
a tow eyelet fixed to the fishing lure body, and configured to couple with a fishing line;
a support rod fixed to the tow eyelet, extending toward the tail end of the fishing lure body, and at least partially embedded in the fishing lure body;
a first hook eyelet partially imbedded in the fishing lure body, and fixed to the support rod;
a first hook coupled to the first hook eyelet;
a second hook eyelet partially imbedded in the fishing lure body, and fixed to the support rod; and
a second hook coupled to the second hook eyelet.

2. The fishing lure of claim 1, wherein the fishing lure body is tapered proximate its forward end.

3. The fishing lure of claim 1, wherein the fishing lure body is tapered proximate its tail end.

4. The fishing lure of claim 1, wherein the bait portal includes an elongated aperture through the fishing lure body to the internal cavity that is elongated respective to the longitudinal axis.

5. The fishing lure of claim 4, wherein the bait portal is centered on the fishing lure body between the forward end and the tail end.

6. The fishing lure of claim 5, wherein the bait portal is positioned between the left lobe and the right lobe.

7. The fishing lure of claim 1, wherein the plurality of apertures includes at least two apertures positioned on the left lobe.

8. The fishing lure of claim 7, wherein the plurality of apertures includes at least two apertures positioned on the right lobe.

9. The fishing lure of claim 1, wherein the tow eyelet is fixed to the fishing lure body proximate the forward end of the fishing lure body.

10. The fishing lure of claim 1, wherein the first hook eyelet is positioned proximate the bottom side of the fishing lure body.

11. The fishing lure of claim 1, wherein the second hook eyelet is positioned proximate the tail end of the fishing lure body.

12. The fishing lure of claim 10, wherein the first hook eyelet is positioned on the bottom side of the fishing lure body between its forward end and its tail end.

13. The fishing lure of claim 12, wherein the first hook eyelet is positioned in a center portion of the bottom side of the fishing lure body between its forward end its tail end.

14. The fishing lure of claim 1, further comprising a pair of imitation eyes fixed to the fishing lure body.

15. The fishing lure of claim 14, wherein one of the pair of imitation eyes is positioned on the left side of the fishing lure body, and the other of the pair of imitation eyes is positioned on the right side of the fishing lure body.

16. The fishing lure of claim 15, wherein the pair of imitation eyes are further positioned proximate the forward end of the fishing lure body.

17. A fishing lure comprising:
a fishing lure body defining a forward end, tail end, a right side, a left side, a top side, a bottom side, and a longitudinal axis extending between the forward end and the tail end, the fishing lure body having a streamline shape along the longitudinal axis and including a left lobe and a right lobe on each side of the longitudinal axis, the fishing lure body including an internal cavity, a bait portal, and a plurality of apertures through the fishing lure body to the internal cavity, said internal cavity sized and dimensioned to retain an item of bait, said bait portal configured to receive the item of bait into the internal cavity, said plurality of apertures positioned on the top side of each of the left lobe and the right lobe; a tow eyelet fixed to the fishing lure body, and configured to couple with a fishing line; a support rod fixed to the tow eyelet, extending toward the tail end of the fishing lure body, and at least partially embedded in the fishing lure body; a first hook eyelet partially imbedded in the fishing lure body, and fixed to the support rod; a first hook coupled to the first hook eyelet; a second hook eyelet partially imbedded in the fishing lure body, and fixed to the support rod; and a second hook coupled to the second hook eyelet;
wherein the fishing lure body is tapered proximate its forward end;
wherein the fishing lure body is tapered proximate its tail end;
wherein the bait portal includes an elongated aperture through the fishing lure body to the internal cavity that is elongated respective to the longitudinal axis;
wherein the bait portal is centered on the fishing lure body between the forward end and the tail end;
wherein the bait portal is positioned between the left lobe and the right lobe;
wherein the plurality of apertures includes at least two apertures positioned on the left lobe;
wherein the plurality of apertures includes at least two apertures positioned on the right lobe;
wherein the tow eyelet is fixed to the fishing lure body proximate the forward end of the fishing lure body;
wherein the first hook eyelet is positioned proximate the bottom side of the fishing lure body;
wherein the second hook eyelet is positioned proximate the tail end of the fishing lure body;
wherein the first hook eyelet is positioned on the bottom side of the fishing lure body between its forward end and its tail end;
wherein the first hook eyelet is positioned in a center portion of the bottom side of the fishing lure body between its forward end its tail end;
further comprising a pair of imitation eyes fixed to the fishing lure body;
wherein one of the pair of imitation eyes is positioned on the left side of the fishing lure body, and the other of the pair of imitation eyes is positioned on the right side of the fishing lure body; and
wherein the pair of imitation eyes are further positioned proximate the forward end of the fishing lure body.

18. The fishing lure of claim 17, further comprising set of instructions; and
wherein the fishing lure is arranged as a kit.

19. A method of using a fishing lure, the method comprising the steps of:
providing a fishing lure including:
a fishing lure body defining a forward end, tail end, a right side, a left side, a top side, a bottom side, and a longitudinal axis extending between the forward end and the tail end, the fishing lure body having a streamline shape along the longitudinal axis and including a left lobe and a right lobe on each side of the longitudinal axis, the fishing lure body including an internal cavity, a bait portal, and a plurality of apertures through the fishing lure body to the internal cavity, said internal cavity sized and dimensioned to retain an item of bait, said bait portal configured to receive the item of bait into the internal cavity, said plurality of apertures positioned on the top side of each of the left lobe and the right lob a tow eyelet fixed to the fishing lure body, and configured to couple with a fishing line,
a support rod fixed to the tow eyelet, extending toward the tail end of the fishing lure body, and at least partially embedded in the fishing lure body, a first hook eyelet partially imbedded in the fishing lure body, and fixed to the support rod; a first hook coupled to the first hook eyelet,
a second hook eyelet partially imbedded in the fishing lure body, and fixed to the support rod; and
a second hook coupled to the second hook eyelet; and
placing a live bait inside the internal cavity of the fishing lure body.

20. The method of claim 19, further comprising the steps of:
securing a fishing line to the tow eyelet; and
placing the fishing lure into a body of water.
